(19) United States
(12) Patent Application Publication
(10) Pub. No.: US 2026/0035892 A1
(43) Pub. Date: Feb. 5, 2026

(54) SECURE FIRE HYDRANT CAP AND ACTUATING WRENCH THEREFOR

(71) Applicant: Hydra-Shield Mfg. Inc., Dallas, TX (US)

(72) Inventors: J. Paul ROUSE, Dallas, TX (US); Justin P. SCHAEFER, Cedar Hill, TX (US); Michael T. BALDWIN, Cedar Hill, TX (US)

(73) Assignee: Hydra-Shield Mfg. Inc., Dallas, TX (US)

(21) Appl. No.: 19/290,772

(22) Filed: Aug. 5, 2025

Related U.S. Application Data
(60) Provisional application No. 63/679,449, filed on Aug. 5, 2024.

(51) Int. Cl. E03B 9/06; B25B 13/48

(52) U.S. Cl. CPC E03B 9/06; B25B 13/48

(57) ABSTRACT

A fire hydrant security system includes a fire hydrant cap and a specialized wrench for the fire hydrant cap. The cap includes: a body having an open end and a closed end; internal threads disposed within the open end and configured for engagement with a fire hydrant outlet; a first circular depression centrally disposed on an exterior of the closed end; and a second circular depression disposed within the first circular depression and positioned between a center of the first circular depression and a periphery of the first circular depression. The specialized wrench includes: an elongated handle; a first circular protuberance disposed on the elongated handle and configured to fill the first circular depression; and a second circular protuberance disposed on the first circular protuberance, positioned between a center of the first circular protuberance and a periphery of the first circular protuberance, and configured to fill the second circular depression.

### CROSS REFERENCE TO RELATED APPLICATION

This application claims the benefit of U.S. Provisional Patent Application No. 63/679,449, filed on Aug. 5, 2024, which is hereby incorporated by reference for all purposes as if fully set forth herein.

### FIELD OF THE INVENTION

The subject matter disclosed herein relates to fire hydrant access and, in particular, to a secure fire hydrant cap and an actuating wrench therefor.

### BACKGROUND OF THE INVENTION

In many communities, fresh water has become, or is becoming, a valuable commodity which is metered to its users. A ubiquitous source of fresh water in urban and suburban communities is the enormous number of fire hydrants distributed throughout these communities. In order to protect such communities from fire, these hydrants must be readily available to fire departments. Unfortunately, in many areas, hydrants are opened by residents and others in order to obtain quantities of fresh water, sometimes for recreational purposes and at other times for sale to fresh water users. For example, tanker trucks frequently fill illegally at fire hydrants and sell stolen water to swimming pool owners. From time to time vandals damage, open and waste water from fire hydrants for no rational purpose whatsoever.

In order to protect water supplies and prevent fire hydrants from being opened by people other than those having authority to do so, vandal-proof security arrangements have been developed. For example, U.S. Pat. No. 3,929,152 to Graham discloses a vandal-proof cap. This vandal-proof cap relies upon a steel cap which is threaded on the outlet of a fire hydrant. The steel cap has a dome shaped outer surface with a series of grooves therein which require the use of a special wrench having a gripping portion with shoulders for engaging the grooves. The cap of Graham has been improved over the years by providing a slip ring which minimizes the effectiveness of band-type wrenches or other large wrenches in illegally removing the cap. Unfortunately, vandals are beginning to defeat the Graham device by pounding the slip ring with a sledge hammer to weld the slip ring to the cap so that purchase of the slip ring with the cap enables one to apply sufficient torque to remove the cap with tools other than the specially configured tool provided only to fire departments.

In addition, it has been found that the specially configured tool or wrench utilized to back the cap off can slip from the cap. Since the wrench is large and the torque applied by the wrench is considerable, if the wrench slips there is risk of injury to the firemen using the wrench and to any one standing near the wrench.

To address the problems with the Graham arrangement, U.S. Pat. No. 5,033,501 to Stehling introduced a fire hydrant cap and actuating tool for use therewith that provided enhanced security for fire hydrants and increased safety when using the tool. The Stehling cap is forged of 8620 carbon steel; is provided with an internal steel lock washer of cadmium plate steel, and includes thereon a forged, external slip ring of 8620 carbon steel with lubrication between the slip ring and cap. The tool which is used in combination with the Stehling cap includes a gripper which fits under the slip ring to prevent the tool from slipping, a spanner wrench and a hexagonal socket with a screw for gripping rounded-off valve stems.

Despite these improvements, operating the wrench and gripper arrangement of Stehling may take up valuable firefighting time and the wrench has limited utility. Accordingly, it would be desirable to have a secure fire hydrant cap and wrench combination that defeats vandals, allows swift operation, and has increased utility.

### SUMMARY OF THE INVENTION

The present disclosure is directed, in a first aspect, to a secure fire hydrant cap that includes a body having an open first end and a closed second end. The open first end is threaded with internal threads that are configured for engagement with corresponding threads of a fire hydrant outlet. An exterior of the closed second end has a first circular depression disposed centrally thereon. A second circular depression is disposed within the first circular depression and positioned between a center of the first circular depression and a periphery of the first circular depression. In use, the first and second circular depressions act as a mating surface with a specialized wrench in order to secure the cap from unauthorized access.

In one or more embodiments, the first circular depression may have a substantially uniform first depth, and/or the second circular depression may have a substantially uniform second depth.

In various embodiments, the body may be formed of 6061-T6 aluminum.

In an embodiment, an anti-corrosion coating may be disposed on the body.

In a further embodiment, the anti-corrosion coating may be an anodized coating or a ceramic coating.

In yet another embodiment, the second circular depression may be disposed substantially adjacent the periphery of the first circular depression.

In an embodiment, the body of the fire hydrant cap may be substantially cylindrical.

In another embodiment, a substantially cylindrical slip ring may be disposed on an outer periphery of the body.

In a further embodiment, a center of the first circular depression may be disposed on a central axis of the substantially cylindrical body.

In another embodiment, the present disclosure is directed to a fire hydrant security system including a fire hydrant cap and a specialized wrench for the fire hydrant cap. The fire hydrant cap includes: a body having an open first end and a closed second end; internal threads disposed within the open first end and configured for engagement with a fire hydrant outlet; a first circular depression centrally disposed on an exterior of the closed second end; and a second circular depression disposed within the first circular depression and positioned between a center of the first circular depression and a periphery of the first circular depression. The specialized wrench includes: an elongated handle; a first circular protuberance disposed on the elongated handle and configured to fill the first circular depression; and a second circular protuberance disposed on the first circular protuberance, positioned between a center of the first circular protuberance and a periphery of the first circular protuberance, and configured to fill the second circular depression.

In an embodiment, the first circular depression may have a substantially uniform first depth and the second circular depression may have a substantially uniform second depth.

In another embodiment, the first circular protuberance may have a substantially uniform first height matching the first depth and the second circular protuberance may have a substantially uniform second height matching the second depth.

In yet another embodiment, the body may be formed of 6061-T6 aluminum.

In a further embodiment of the system, the elongated handle may have a substantially flat side and the first and second circular protuberances may be disposed to extend from the substantially flat side.

In an embodiment of the system, the body of the fire hydrant cap may be substantially cylindrical.

In another embodiment of the system, the cap may further include a substantially cylindrical slip ring disposed on an outer periphery of the body.

In yet another embodiment, an anti-corrosion coating may be disposed on the body, wherein the anti-corrosion coating may be an anodized coating or a ceramic coating.

In a further embodiment, a center of the first circular depression may be disposed on a central axis of the substantially cylindrical body.

In yet another embodiment, the present disclosure is directed to a specialized wrench for a fire hydrant cap. The specialized wrench includes an elongated handle, a first circular protuberance disposed on the elongated handle and configured to fill a first circular depression disposed on the fire hydrant cap, a second circular protuberance disposed on the first circular protuberance, positioned between a center of the first circular protuberance and a periphery of the first circular protuberance, and configured to fill a second circular depression disposed within the first circular depression of the fire hydrant cap.

In an embodiment, the first circular protuberance may have a substantially uniform first height and the second circular protuberance may have a substantially uniform second height.

In another embodiment, the elongated handle may have a substantially flat side and the first and second circular protuberances may be disposed to extend from the substantially flat side.

In a further embodiment, the substantially flat side may include a plurality of openings configured to fit a corresponding plurality of nut sizes used in firefighting.

In yet another embodiment, the substantially flat side may include a spanner portion configured to fit one or more Storz connections and/or rocker lugs.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a perspective view of an outside of a fire hydrant cap in accordance with an embodiment of the invention;

FIG. 2 is a perspective view of an inside of a fire hydrant cap in accordance with an embodiment of the invention;

FIG. 3 is a plan view of a specialized wrench in accordance with an embodiment of the invention; and

FIG. 4 is a perspective view of a fire hydrant with the fire hydrant cap in accordance with an embodiment of the invention.

### DETAILED DESCRIPTION OF THE INVENTION

The embodiments of the present disclosure can comprise, consist of, and consist essentially of the features and/or steps described herein, as well as any of the additional or optional elements, components, steps, or limitations described herein or would otherwise be appreciated by one of skill in the art.

The present disclosure is directed to a secure fire hydrant cap and a specialized wrench therefor that uses a unique interface that includes a plurality of circular elements to provide a tamper resistant actuating means. The secure fire hydrant cap may also employ a slip ring that rotates with respect to the cap to prevent use of band wrenches.

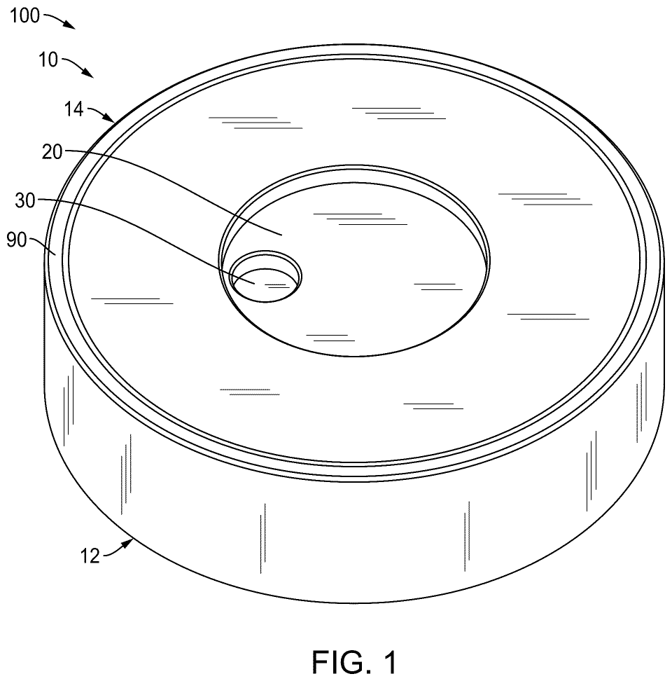

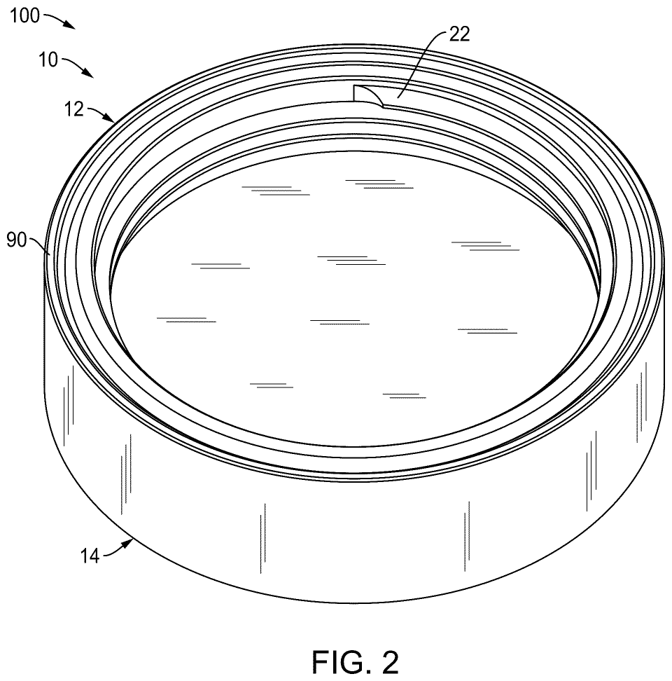

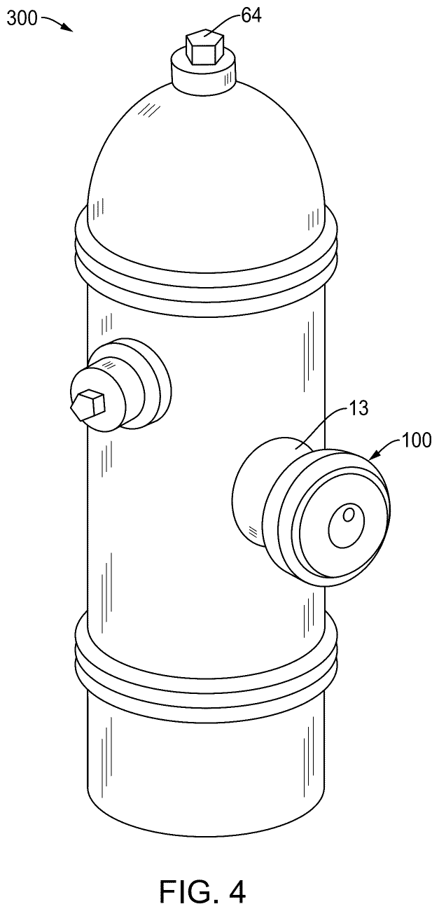

Referring to FIGS. 1 and 2, an embodiment of the secure fire hydrant cap 10 includes a body 10 having an open first end 12 and a closed second end 14. As shown in FIG. 2, the open first end 12 is threaded with internal threads 22 that are configured for engagement with corresponding threads of a fire hydrant outlet 13 (see FIG. 4).

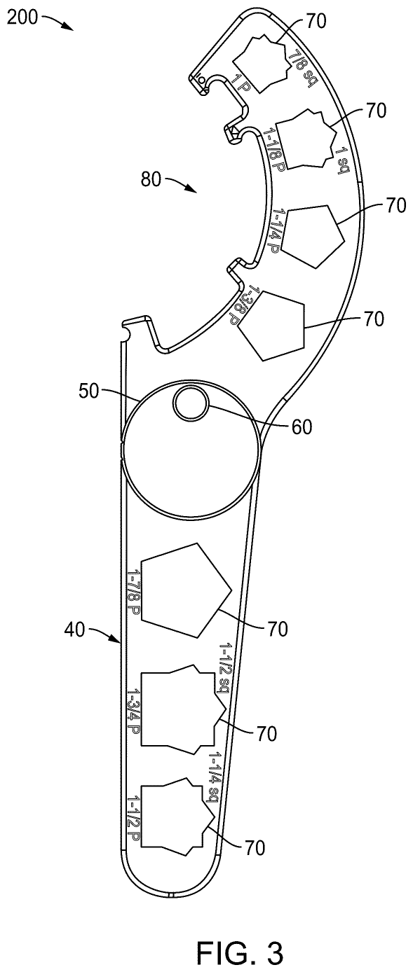

As illustrated in FIG. 1, an exterior of the closed second end 14 has a first circular depression 20 disposed centrally thereon. A second circular depression 30 is disposed within the first circular depression 20 and positioned between a center of the first circular depression 20 and a periphery of the first circular depression 20. In use, the first circular depression 20 and second circular depression 30 act as a mating surface or interface with a specialized wrench 200 (see FIG. 3) in order to secure the cap 100 from unauthorized access when used on a fire hydrant 300 (see FIG. 4).

As illustrate in the embodiment of FIG. 1, the first circular depression 20 may have a substantially uniform first depth, and the second circular depression 30 may have a substantially uniform second depth. However, embodiments are not limited to the use of such uniform depths, and other embodiments including but not limited to conical, sloping, or undulating depths may also be used without departing from the concepts of the invention. In order to provide some leverage, the second circular depression 30 may be disposed substantially adjacent the periphery of the first circular depression 20.

Referring to FIGS. 1 and 2, in an embodiment of the inventive concepts, the body 10 of the fire hydrant cap 100 may be substantially cylindrical and a substantially cylindrical slip ring 90 may be disposed on an outer periphery of the body. Slip ring 90 may prevent the removal of cap 100 with a band wrench by freely rotating. Thus, if an attempt is made to grip the cap 100 with a band wrench or similar device where the curvature of the cap approaches the cylindrical surface of the outlet 13 (see FIG. 4), slip ring 90 will rotate with respect to the cap 100. In an embodiment, a center of the first circular depression 20 may be disposed on a central axis of the substantially cylindrical body 10 so as to center the specialized wrench 200 (see FIG. 3) on the cap 100 when in use.

The body 10 of fire hydrant cap 100 may be provided in various sizes to match various size outlets 13 on fire hydrants 300 (see FIG. 4). For example, the cap 100 may be provided in 2½ inch, 4 inch, and 4½ inch sizes.

In one or more embodiments, the body 10 may be formed of 6061-T6 aluminum. However, embodiments are not limited to the use of 6061-T6 aluminum, and other embodiments including but not limited to 7000 series aluminum, hardened steel, and the like may also be used without departing from the concepts of the invention.

In one or more embodiments, an anti-corrosion coating may be disposed on the body 10 and/or slip ring 90. For example, the anti-corrosion coating may be an anodized coating or a ceramic coating disposed on the body 10 and/or slip ring 90. However, embodiments are not limited to the use of anodized or ceramic coatings, and other embodiments including but not limited to power coating, industrial paint, and the like may also be used without departing from the concepts of the invention.

In another embodiment, the present disclosure is directed to a fire hydrant security system including a fire hydrant cap 100 of FIGS. 1, 2, and 4, and a specialized wrench 200 for actuating the fire hydrant cap 100.

Referring to FIG. 3, in an embodiment, the specialized wrench 200 includes an elongated handle 40 to provide leverage and grip to the wrench 200. In an embodiment, the handle 40 may be substantially flat. Such a flat handle 40 provides a wide cross-section to resist torque, yet minimizes the space and amount of material required for fabrication. Edges of handle 40 may include raised rounded edges for comfort in use.

Wrench 200 further includes a first circular protuberance 50 disposed on the elongated handle 40 at a location where the handle 40 may provide leverage thereto. The protuberance 50 may be configured to fill the first circular depression 20 on the cap 100 so as to centrally locate an interface of the wrench 200 with interface of the cap 100. Wrench 200 also includes a second circular protuberance 60 disposed on the first circular protuberance 50. The second circular protuberance 60 is positioned off center with respect to the first circular protuberance 50 in order to provide some leverage. Specifically, the second circular protuberance may be positioned between a center of the first circular protuberance 50 and a periphery of the first circular protuberance 50, and is configured to substantially fill the second circular depression 30 in order to provide an actuation interface for the wrench 200 to rotate cap 100 along threads 22.

In order to have a secure interface between wrench 200 and cap 100, the first circular protuberance 50 should substantially fill the first circular depression 20 and the second circular protuberance 60 should be positioned and dimensioned to substantially fill the second circular depression 30. Thus, in an embodiment where the first circular depression 20 has a substantially uniform first depth and the second circular depression 30 has a substantially uniform second depth, the first circular protuberance 50 may have a substantially uniform first height matching the first depth and the second circular protuberance 60 may have a substantially uniform second height matching the second depth.

In one or more embodiments of the system, the elongated handle 40 may, as discussed above, have a substantially flat side, and the first circular protuberance 50 and second circular protuberance 60 may be disposed to extend transversely from the substantially flat side.

With reference to FIG. 3, in one or more embodiments, the substantially flat side of wrench 200 may include a plurality of openings 70 configured to fit a corresponding plurality of nut sizes used in firefighting, such as the valve stem nut 64 of fire hydrant 300 in FIG. 4, or other nuts associated with pumper equipment, pumper/steamer nozzles, and hose nozzles. In an example embodiment illustrated in FIG. 3, openings are provided for 1½ inch, 1⅜ inch, an 1⅞ inch pentagonal nuts, and combination openings are provided for 1 inch pentagonal/⅞ inch square, 1⅛ inch pentagonal/1 inch square, 1¾ inch pentagonal/1½ inch square, and 1½ inch pentagonal/1¼ inch square nuts.

As further illustrated in the embodiment of FIG. 3, the substantially flat side of wrench 200 may include a spanner portion 80 configured to fit one or more Storz connections and/or rocker lugs.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A fire hydrant cap, comprising:
a body having an open first end and a closed second end;
internal threads disposed within the open first end and configured for engagement with a fire hydrant outlet;
a first circular depression centrally disposed on an exterior of the closed second end; and
a second circular depression disposed within the first circular depression and positioned between a center of the first circular depression and a periphery of the first circular depression.

2. The fire hydrant cap of claim 1, wherein the first circular depression has a substantially uniform first depth.

3. The fire hydrant cap of claim 1, wherein the second circular depression has a substantially uniform second depth.

4. The fire hydrant cap of claim 1, wherein the body is formed of 6061-T6 aluminum.

5. The fire hydrant cap of claim 1, wherein the second circular depression is disposed substantially adjacent the periphery of the first circular depression.

6. The fire hydrant cap of claim 1, wherein the body is substantially cylindrical.

7. The fire hydrant cap of claim 6, further comprising a substantially cylindrical slip ring disposed on an outer periphery of the body.

8. The fire hydrant cap of claim 4, further comprising an anti-corrosion coating disposed on the body.

9. The fire hydrant cap of claim 8, wherein the anti-corrosion coating comprises an anodized coating or a ceramic coating.

10. The fire hydrant cap of claim 6, wherein a center of the first circular depression is disposed on a central axis of the substantially cylindrical body.

11. A fire hydrant security system, comprising:
a fire hydrant cap; and
a specialized wrench for the fire hydrant cap, wherein:
the fire hydrant cap includes:
a body having an open first end and a closed second end;
internal threads disposed within the open first end and configured for engagement with a fire hydrant outlet;
a first circular depression centrally disposed on an exterior of the closed second end; and
a second circular depression disposed within the first circular depression and positioned between a center of the first circular depression and a periphery of the first circular depression, and wherein:
the specialized wrench includes:
an elongated handle;
a first circular protuberance disposed on the elongated handle and configured to fill the first circular depression; and
a second circular protuberance disposed on the first circular protuberance, positioned between a center of the first circular protuberance and a periphery of the first circular protuberance, and configured to fill the second circular depression.

12. The fire hydrant security system of claim 11, wherein the first circular depression has a substantially uniform first depth and the second circular depression has a substantially uniform second depth.

13. The fire hydrant security system of claim 12, wherein the first circular protuberance has a substantially uniform first height matching the first depth and the second circular protuberance has a substantially uniform second height matching the second depth.

14. The fire hydrant security system of claim 11, wherein the body is formed of 6061-T6 aluminum.

15. The fire hydrant security system of claim 11, wherein the elongated handle has a substantially flat side and the first and second circular protuberances are disposed to extend from the substantially flat side.

16. The fire hydrant security system of claim 11, wherein the body is substantially cylindrical.

17. The fire hydrant security system of claim 16, further comprising a substantially cylindrical slip ring disposed on an outer periphery of the body.

18. The fire hydrant security system of claim 14, further comprising an anti-corrosion coating disposed on the body, wherein the anti-corrosion coating is an anodized coating or a ceramic coating.

19. The fire hydrant security system of claim 16, wherein a center of the first circular depression is disposed on a central axis of the substantially cylindrical body.

20. A specialized wrench for a fire hydrant cap, comprising:
an elongated handle;
a first circular protuberance disposed on the elongated handle and configured to fill a first circular depression disposed on the fire hydrant cap; and
a second circular protuberance disposed on the first circular protuberance, positioned between a center of the first circular protuberance and a periphery of the first circular protuberance, and configured to fill a second circular depression disposed within the first circular depression of the fire hydrant cap.

21. The specialized wrench of claim 20, wherein the first circular protuberance has a substantially uniform first height and the second circular protuberance has a substantially uniform second height.

22. The specialized wrench of claim 20, wherein the elongated handle has a substantially flat side and the first and second circular protuberances are disposed to extend from the substantially flat side.

23. The specialized wrench of claim 22, wherein the substantially flat side comprises a plurality of openings configured to fit a corresponding plurality of nut sizes used in firefighting.

24. The specialized wrench of claim 22, wherein the substantially flat side comprises a spanner portion configured to fit one or more Storz connections and/or rocker lugs.
